(19) United States
(12) Patent Application Publication
(10) Pub. No.: US 2017/0323230 A1
(43) Pub. Date: Nov. 9, 2017

(54) EVALUATING KEYWORD PERFORMANCE

(71) Applicants: Scott Aaron Bailey, Mission Viejo, CA (US); Stanley Charles Ross Wolfe, Paris (FR); Deepti Bhatnagar, Palo Alto, CA (US); Skirmantas Kligys, Manhattan Beach, CA (US)

(72) Inventors: Scott Aaron Bailey, Mission Viejo, CA (US); Stanley Charles Ross Wolfe, Paris (FR); Deepti Bhatnagar, Palo Alto, CA (US); Skirmantas Kligys, Manhattan Beach, CA (US)

(73) Assignee: Google Inc.

(21) Appl. No.: 13/590,698

(22) Filed: Aug. 21, 2012

(51) Int. Cl. G06Q 10/06; G06F 17/30

(52) U.S. Cl. CPC G06Q 10/063; G06F 17/30038

(57) ABSTRACT

Systems and methods for evaluating keyword performance include receiving history data indicative of online actions performed regarding one or more advertisements. A set of one or more keywords may be associated with the one or more advertisements. A performance metric for the set of one or more keywords may be determined using the history data, as well as a confidence interval for the performance metric. Confidence intervals for the performance metrics of different sets of keywords may be sorted and provided.

### BACKGROUND

The present disclosure relates generally to online advertising systems. The present disclosure more specifically relates to evaluating keyword performance for an online advertiser.

Websites and other online sources may provide content to client devices relating to any number of different topics. For example, a first website may be devoted to the latest golf equipment and a second website may be devoted to automobiles. Users having an interest in a particular topic may navigate to an online content source related to that topic. In some cases, a user may utilize a search engine to find online content of interest to the user. For example, a user may search the Internet for reviews of the latest golf equipment and the search engine may return a listing of websites devoted to reviewing golf equipment. The user may navigate between the various websites in the listing to receive content of relevance to the user.

### SUMMARY

Implementations of the systems and methods for evaluating keyword performance are described herein. One implementation is a computerized method for evaluating keyword performance. The method includes receiving, at a processing circuit, history data indicative of online actions performed regarding one or more advertisements, the one or more advertisements being associated with a set of one or more keywords used to select the one or more advertisements for presentation at client devices. The method also includes determining, by the processing circuit, a performance metric for the set of one or more keywords using the history data. The method yet further includes generating, by the processing circuit, a confidence interval for the performance metric for the set of one or more keywords. The method also includes sorting, by the processing circuit, a plurality of confidence intervals, each confidence interval being associated with a performance metric for a set of one or more keywords. The method further includes providing, by the processing circuit, the sorted confidence intervals.

Another implementation is a system for evaluating keyword performance. The system includes a processing circuit operable to receive history data indicative of online actions performed regarding one or more advertisements, the one or more advertisements being associated with a set of one or more keywords used to select the one or more advertisements for presentation at client devices. The processing circuits is also operable to determine a performance metric for the set of one or more keywords using the history data and to generate a confidence interval for the performance metric for the set of one or more keywords. The processing circuit is further operable to sort a plurality of confidence intervals, each confidence interval being associated with a performance metric for a set of one or more keywords. The processing circuit is further operable to provide the sorted confidence intervals.

A further implementation is a computer-readable storage medium having instructions therein, the instructions being executable by a processor to cause the processor to perform operations. The operations include receiving history data indicative of online actions performed regarding one or more advertisements, the one or more advertisements being associated with a set of one or more keywords used to select the one or more advertisements for presentation at client devices. The operations also include determining a performance metric for the set of one or more keywords using the history data. The operations further include generating a confidence interval for the performance metric for the set of one or more keywords and sorting a plurality of confidence intervals, each confidence interval being associated with a performance metric for a set of one or more keywords. The operations also include providing the sorted confidence intervals.

These implementations are mentioned not to limit or define the scope of this disclosure, but to provide examples of implementations to aid in understanding thereof.

### BRIEF DESCRIPTION OF THE DRAWINGS

The details of one or more implementations are set forth in the accompanying drawings and the description below. Other features, aspects, and advantages of the disclosure will become apparent from the description, the drawings, and the claims, in which:

FIG. 1 is a block diagram of a computer system;

FIG. 2 is an illustration of an electronic display showing an example search result webpage;

FIG. 3 is an illustration of an electronic display showing an example webpage;

FIG. 4 is a flow diagram of an example process for evaluating keyword performance; and

FIG. 5 is an illustration of an indication of keyword performance being provided to an electronic display.

Like reference numbers and designations in the various drawings indicate like elements.

### DETAILED DESCRIPTION

According to some aspects of the present disclosure, online content, such as an advertisement, may be selected for a user and presented in conjunction with other online content. In some cases, a search engine may receive advertising revenue by allowing an advertiser to place an advertisement with the search results, when certain keywords or phrases are queried. For example, an online retailer of golf equipment may pay for the ability to place an advertisement whenever a user searches for the phrase “best golf clubs.” Similarly, a provider of a website devoted to a particular topic may receive advertising revenue by allowing an advertiser to place an advertisement in conjunction with the website (e.g., embedded in a webpage, as a popup advertisement, etc.). An advertiser may opt to place an advertisement on such a website based on keywords or phrases found on the website. For example, the online retailer of golf clubs may choose to place an advertisement on webpages that contain the phrase “golf clubs.”

In some cases, advertisers may compete for the ability to place an advertisement with search results or on a content provider's webpage. For example, advertisers may participate in an advertising auction conducted by an advertising system, to determine which advertisement is served. The advertising system may user various factors to determine which advertisement is provided with the search results or a provider's webpage. For example, the results of the auction may be based in part on an advertiser's bid or how well the advertiser's advertisement has previously performed.

An advertising system may include various utilities to facilitate the purchasing of advertisement space on a search result webpage or a content provider's webpage. In some implementations, the advertising system may place bids in an auction on behalf of an advertiser, based on various parameters set by the advertiser. Such parameter may include, for example, the advertiser's budget (e.g., daily budget, monthly budget, total budget, etc.), the keywords or phrases on which the advertiser wishes to bid, whether the advertisement is to appear with search results from a search engine, and whether the advertisement is to appear on a content provider's webpage. In some implementations, the advertising system may be configured to adjust an advertiser's bids based on a target goal for the advertiser, such as the average amount of money the advertiser wishes to spend per advertisement that leads to a user making a purchase from the advertiser.

According to some implementations, an advertising system may be configured to report on various performance metrics for an advertiser's advertisements. Performance metrics may include, but are not limited to, how many times an advertiser's advertisement was provided to a user, a click through rate (“CTR”), a cost per click (“CPC”), a conversion rate (“CVR”), and a cost per action (“CPA”). In general, a conversion refers to a user performing a certain type of action associated with an advertisement. For example, a conversion may be the user clicking on the advertisement and making a purchase at the advertiser's website, downloading software from the advertiser's website, adding his or her contact information to a contact list, etc. A CPC or CVR value may be calculated by dividing the amount of money spent by the advertiser by the number of clicks or conversions for the advertisement.

Performance metrics may be associated with a particular keyword or set of keywords used to determine whether the advertiser is to participate in an advertising auction. For example, the advertiser may specify different sets of words or phrases to the advertising system, as part of an advertising campaign. Whenever a user searches for the corresponding words or phrases, a bid may be generated on behalf of the advertiser in an advertising auction. For example, an advertiser may specify that they wish to advertise whenever a user searches for the phrases “best golf clubs” or “golf club ratings.” However, the different sets of words may have different performance metrics. For example, assume that an advertisement has a CTR of 6% when the phrase “best golf clubs” is searched and a CTR of 11% when the phrase “golf club ratings” is searched. In such a case, the advertiser may choose to stop using the phrase “best golf clubs,” to devote more of the advertiser's budget to the higher performing phrase.

In some cases, a performance metric for a set of one or more keywords associated with an advertisement may not be a reliable predictor of future user interactions with the advertisement. For example, assume that an advertisement is presented to users that search for “best golf clubs” a total of two times. Also, assume that one of the two users clicks on the advertisement. In such a case, the CTR associated with “best golf clubs” would be 50%. However, this performance metric is not a reliable predictor of how future users will react to the advertisement, due to its low sample size. For example, the CTR may drop to 5% after the advertisement is presented two hundred times to users. Thus, a performance metric for a set of keywords may be more or less reliable based on how many times its associated advertisements are presented to users.

According to various implementations, the reliability of a performance metric may be quantified and presented to an advertiser. For example, the advertising system may present an advertiser with a report that lists the performance metrics for different sets of keywords and a measure of the reliability of the performance metrics. In some implementations, the reliability of a performance metric may be based on a confidence interval. In general, a confidence interval provides a range of values in which the actual performance metric may exist. For example, an advertisement that was presented twice and clicked once may have a CTR of 50% and a confidence interval for its CTR of 0.0945-0.9055, using a 95% confidence interval. In other words, there is a 95% confidence that a subsequent CTR for the advertisement after further impressions lies somewhere between 0.0945-0.9055. In a second example, an advertisement that was presented one hundred times and clicked fifty times may have the same CTR of 50%, but a confidence interval for its CTR of 0.4038-0.5962. Since the second example has many more data points than the first example, the confidence interval for its CTR is much smaller, indicating a higher degree of reliability than in the first example. In some implementations, the confidence intervals across multiple sets of keywords may be sorted. Sorting the confidence intervals may allow an advertiser or other interested party to identify the highest or lowest performing sets of keywords, as well as how reliable their corresponding performance metrics are.

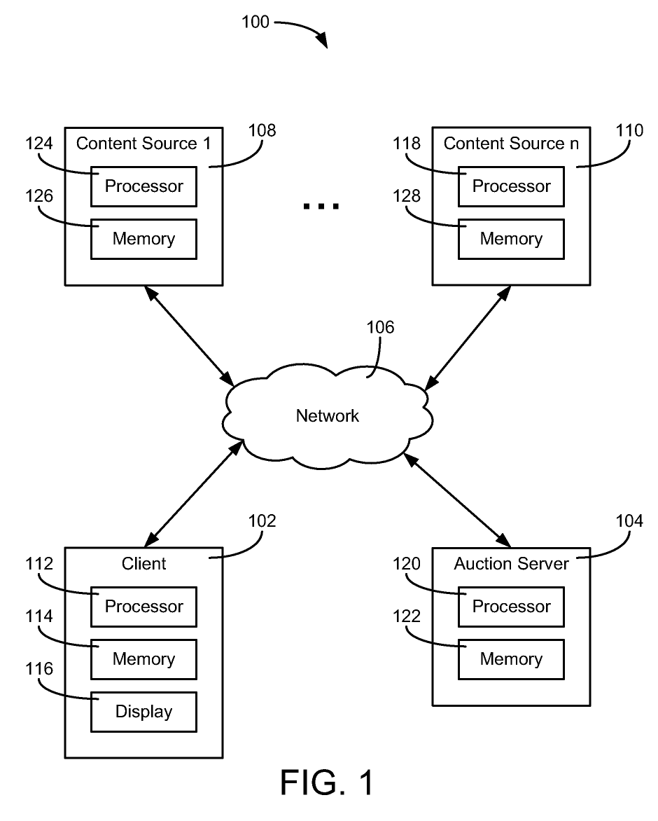

Referring to FIG. 1, a block diagram of a computer system 100 in accordance with a described implementation is shown. System 100 includes a client 102 which communicates with other computing devices via a network 106. Client 102 may execute a web browser or other application to retrieve content from other devices over network 106. For example, client 102 may communicate with any number of content sources 108, 110 (e.g., a first content source through nth content source). Content sources 108, 110 may provide webpage data and/or other content (e.g., text documents, PDF files, and other forms of electronic documents) to client 102. In some implementations one or more of content sources 108, 110 may be search engines that index content provided by others of content sources 108, 110. In some implementations, computer system 100 may also include an auction server 104 configured to conduct an auction to select content to be provided to client 102. For example, content source 108 may provide a webpage to client 102 that includes an advertisement selected by auction server 104.

Network 106 may be any form of computer network that relays information between client 102, content sources 108, 110, and auction server 104. For example, network 106 may include the Internet and/or other types of data networks, such as a local area network (LAN), a wide area network (WAN), a cellular network, satellite network, or other types of data networks. Network 106 may also include any number of computing devices (e.g., computer, servers, routers, network switches, gateways, etc.) that are configured to receive and/or transmit data within network 106. Network 106 may further include any number of hardwired and/or wireless connections. For example, client 102 may communicate wirelessly (e.g., via WiFi, cellular, radio, etc.) with a transceiver that is hardwired (e.g., via a fiber optic cable, a CAT5 cable, etc.) to other computing devices in network 106.

Client 102 may be any number of different types of user electronic devices configured to communicate via network 106 (e.g., a laptop computer, a desktop computer, a tablet computer, a smartphone, a digital video recorder, a set-top box for a television, a video game console, combinations thereof, etc.). Client 102 is shown to include a processor 112 and a memory 114, i.e., a processing circuit. Memory 114 may store machine instructions that, when executed by processor 112 cause processor 112 to perform one or more of the operations described herein. Processor 112 may include a microprocessor, ASIC, FPGA, etc., or combinations thereof. Memory 114 may include, but is not limited to, electronic, optical, magnetic, or any other storage or transmission device capable of providing processor 112 with program instructions. Memory 114 may include a floppy disk, CD-ROM, DVD, magnetic disk, memory chip, ROM, RAM, EEPROM, EPROM, flash memory, optical media, or any other suitable memory from which processor 112 can read instructions. The instructions may include code from any suitable computer programming language such as, but not limited to, C, C++, C#, Java, JavaScript, Perl, HTML, XML, Python and Visual Basic.

Client 102 may include one or more user interface devices. A user interface device may be any electronic device that conveys data to a user by generating sensory information (e.g., a visualization on a display, one or more sounds, etc.) and/or converts received sensory information from a user into electronic signals (e.g., a keyboard, a mouse, a pointing device, a touch screen display, a microphone, etc.). The one or more user interface devices may be internal to the housing of client 102 (e.g., a built-in display, microphone, etc.) or external to the housing of client 102 (e.g., a monitor connected to client 102, a speaker connected to client 102, etc.), according to various implementations. For example, client 102 may include an electronic display 116, which displays webpages and other data received from content sources 108, 110 and/or auction server 104.

Content sources 108, 110 may be one or more electronic devices connected to network 106 that provide content to client 102. For example, content sources 108, 110 may be computer servers (e.g., FTP servers, file sharing servers, web servers, etc.) or combinations of servers (e.g., data centers, cloud computing platforms, etc.). Content may include, but is not limited to, webpage data, a text file, a spreadsheet, images, and other forms of electronic documents. Similar to client 102, content sources 108, 110 may include processing circuits comprising processors 124, 118 and memories 126, 128, respectively, that store program instructions executable by processors 124, 118. For example, the processing circuit of content source 108 may include instructions such as web server software, FTP serving software, and other types of software that cause content source 108 to provide content via network 106.

According to various implementations, content sources 108, 110 may provide webpage data to client 102 that includes one or more content tags. In general, a content tag may be any piece of webpage code associated with including content, such as an advertisement, with a webpage. A content tag may, for example, define a slot on a webpage for additional content, a slot for out of page content (e.g., an interstitial slot), whether content should be loaded asynchronously or synchronously, whether the loading of content should be disabled on the webpage, whether content that loaded unsuccessfully should be refreshed, the network location of a content source that provides the content (e.g., content sources 108, 110, auction server 104, etc.), a network location (e.g., a URL) associated with clicking on the content, how the content is to be rendered on a display, one or more keywords used to retrieve the content, and other functions associated with providing additional content with a webpage. For example, content source 108 may provide webpage data that causes client 102 to retrieve an advertisement from auction server 104. In another implementation, the advertisement may be selected by auction server 104 and provided by content source 108 as part of the webpage data sent to client 102.

Similar to content sources 108, 110, auction server 104 may be one or more electronic devices connected to network 106 that provide advertisements and/or other content to client 102. Auction server 104 may be a computer server (e.g., FTP servers, file sharing servers, web servers, etc.) or a combination of servers (e.g., a data center, a cloud computing platform, etc.). Auction server 104 may include a processing circuit including a processor 120 and a memory 122 that stores program instructions executable by processor 120. The processing circuit of auction server 104 may be configured to conduct an auction to select content to be provided to client 102. For example, auction server 104 may select content, such as an advertisement, to be provided with a webpage served by content source 108 or 110. In cases in which auction server 104 is a combination of computing devices, processor 120 may represent the collective processors of the devices and memory 122 may represent the collective memories of the devices.

In one implementation, an advertiser or other party may create an account with auction server 104. Associated with the account may be data relating to which advertisements the advertiser wishes to use, a daily budget to spend, one or more sets of keywords that may be used by auction server 104 to select advertisements or other content to be displayed by client 102, and other such parameters. When client 102 visits a webpage that participates in the advertising network, auction server 104 may compare bids among advertisers or other parties to select content to be included on the webpage. In further implementations, auction server 104 may select an advertisement or other content that may be displayed as part of another application, such as a video game, email program, or the like.

After conducting an auction to select an advertisement, auction server 104 may provide the selected advertisement to client 102 or cause client 102 to retrieve the advertisement. For example, auction server 104 may select content from content source 110 to be included with a webpage served by content source 108. In another example, auction server 104 may provide the selected content to client 102. In some implementations, auction server 104 may select content stored in memory 114 of client 102. For example, previously provided content may be cached in memory 114, content may be preloaded into memory 114 (e.g., as part of the installation of an application), or may exist as part of the operating system of client 102. In such a case, auction server 104 may provide an indication of the selection to client 102. In response, client 102 may retrieve the selected content from memory 114 and display it on display 116.

Auction server 104 may be configured to automatically manage budgets for advertisers having accounts on auction server 104. For example, an advertiser may specify a monthly budget and advertising goals to auction server 104. In response, auction server 104 may use the budget and advertising goals to generate auction bids on behalf of the advertiser. Advertising goals may specify desired user actions regarding a particular set of keywords for a topic. A set of keywords may be a set of one or more keywords used as part of an online search or appearing on a visited webpage. User actions specified by an advertiser may include a desired number of impressions (e.g., the number of times an advertisement is presented), clicks (e.g., the number of times a present advertisement is selected by a user), or conversions (e.g., the number of times a clicked advertisement led to the user making an online purchase or performing another such action). In some implementations, the advertiser may specify to auction server 104 a performance goal, such as a CTR, CVR, CPC, or CPA.

In one example, assume that an advertiser has specified a daily budget of $500, and that the advertiser wishes to reach three hundred users per day that search for golf-related webpages. In such a case, the advertiser may associate the advertising campaign with a golf-related set of keywords, e.g., a group of keywords that may be searched via a search engine or may appear on visited webpages. For example, a golf-related set of keywords may include the words “golf,” “hole in one,” “birdie,” etc. Such words may be identified within the text of a search query or appearing on a visited webpage, to identify the search query or webpage as being related to the topic of golf. Auction server 104 may generate a bid for the advertiser based in part on these parameters, when client 102 is used to search for golf-related content or visit a golf-related webpage. If such a bid is the winning bid, auction server 104 may select an advertisement from the winning advertiser to be provided to client 102. In some implementations, an advertiser may specify that a set of keywords is a phrase (e.g., a set of keywords appearing in a specific order). For example, the advertiser may specify that bids are only to be generated when a search query includes the exact phrase “best golf clubs 2012.”

According to various implementations, auction server 104 may receive data indicative of user actions regarding its selected advertisements. For example, auction server 104 may receive an indication from client 102 (e.g., based on a content tag of a visited webpage) or from one of content sources 108-110 that a particular advertisement was clicked after being provided to client 102. Similarly, auction server 104 may receive an indication from client 102 or from one of content sources 108-110 that the user performed a certain action while on the advertiser's website. For example, a cookie may be set on client 102 when the user of client 102 completes an online purchase, subscribes to a marketing list, adds an item to an online shopping cart, downloads software from the advertiser, or performs any other online user action.

Auction server 104 may be configured to report on various metrics regarding the performance of an advertiser's advertisements. In some implementations, auction server 104 may determine one or more performance metrics for any of the advertisements associated with a set of one or more keywords. For example, auction server 104 may determine a CTR, CVR, CPC, CPA, or other performance metric for the one or more advertisements associated with a set of keywords. If an advertiser has specified different sets of keywords as auction parameters, auction server 104 may generate a report that compares the various performance metrics for the different sets. For example, assume that an advertiser specifies that an advertisement is to be presented when users search for the phrases “parking near the Leaning Tower of Pisa” and “parking for the Leaning Tower of Pisa.” Thus, the phrases may differ by using either “near” or “for” in the phrases. Based on this slight difference, the performance metrics for the advertisement may differ based on which phrase is searched by a user. For example, the phrase “parking near the Leaning Tower of Pisa” may have a CTR of 0.19 and the phrase “parking for the Leaning Tower of Pisa” may have a CTR of 0.24.

According to various implementations, auction server 104 may determine a value or range of values to quantify the reliability of a performance metric for a set of one or more keywords. In some implementations, auction server 104 may calculate an associated confidence interval for a performance metric. In general, a confidence interval is a statistical measure of the reliability of a performance metric and signifies that the performance metric's true value falls within the interval with a certain degree of confidence. For example, a 95% confidence interval represents the range of values for a performance metric, with a 95% confidence (e.g., there is a 95% chance that the performance metric will converge to a value within the interval after more data points are obtained).

In general, the smaller the range of values in a confidence interval, the more reliable the value of the performance metric. For example, a CTR of 50% that has a confidence interval of 0.4 to 0.6 may be viewed as being more reliable than a CTR of 50% that has a confidence interval of 0.1 to 0.9. In some implementations, auction server 104 may provide a raw confidence interval for a performance metric as part of a report to an electronic device of an advertiser. In other implementations, the confidence intervals may be normalized and/or aggregated across different performance metrics. For example, the overall performance of a set of one or more keywords may be represented in a report from advertising server 104 by normalizing the confidence intervals for the set's CTR, CPC, CVR, or CPA. In various implementations, auction server 104 may present the actual range of a confidence interval or as a graphical icon. For example, a report may graphically depict the confidence intervals across different sets of keywords, so that an advertiser may quickly determine which performance metrics are the most reliable.

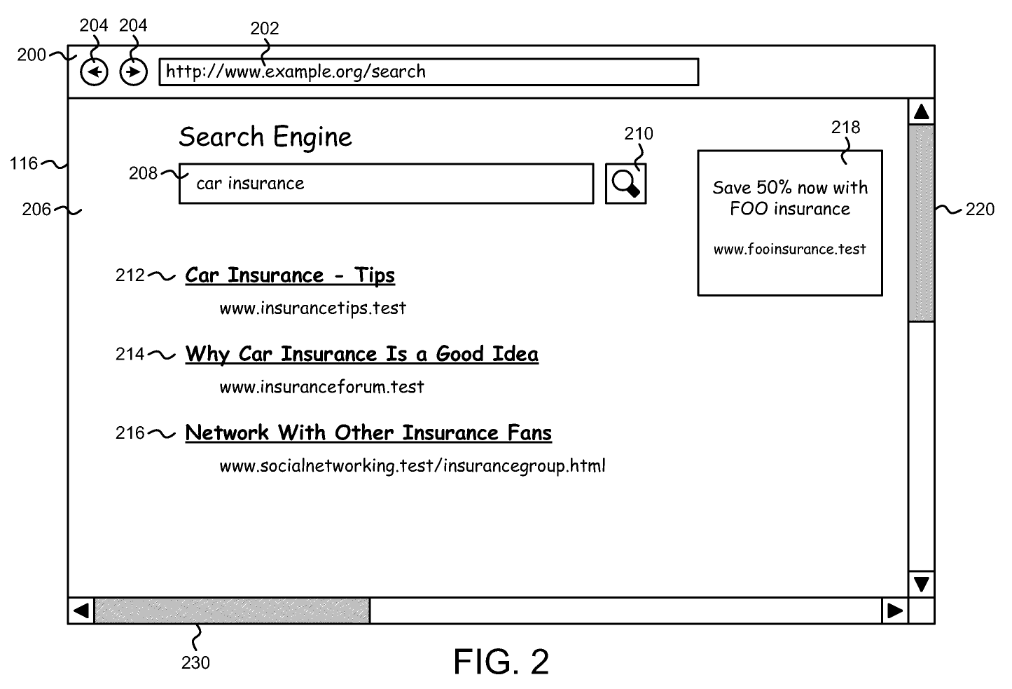

Referring now to FIG. 2, an illustration is shown of electronic display 116 displaying an example search result webpage 206. Electronic display 116 is in electronic communication with processor 112 which causes visual indicia to be displayed on electronic display 116. For example, processor 112 may execute a web browser 200 stored in memory 114 of client 102, to retrieve and display content from other networked devices. Web browser 200 may operate by receiving input of a uniform resource locator (URL) via a field 202 from an input device (e.g., a pointing device, a keyboard, a touchscreen, etc.). For example, the URL, http://www.example.org/search, may be entered into field 202. Processor 112 may use the inputted URL to request data from a content source having a network address that corresponds to the entered URL. In response to the request, the content source may return webpage data and/or other data to client 102 which may be used by client 102 to cause visual indicia to be displayed by electronic display 116.

Web browser 200 displayed on electronic display 116 may include a number of navigational controls associated with webpage 206. For example, web browser 200 may be used to go back or forward to other webpages using inputs 204 (e.g., a back button, a forward button, etc.). Web browser 200 may also include one or more scroll bars 220, which can be used to display parts of webpage 206 that are currently off-screen. For example, webpage 206 may be formatted to be larger than the screen of electronic display 116. In such a case, the one or more scroll bars 220 may be used to change the vertical and/or horizontal position of webpage 206 on electronic display 116.

Webpage 206 may include search results from an online search engine (i.e., a search engine that catalogs multiple websites, a search engine that searches within a particular website, etc.). In some implementations, webpage 206 may include an input field 208 configured to receive a search query. Input field 208 may be part of a search results webpage to allow a user to dynamically change a search query or may be on a separate webpage. After entry of a search query, the search results may be displayed on webpage 206 automatically (i.e., without further input from a user), or in response to a request to perform the search. For example, a user may press the Enter key on a keyboard to perform the search or select icon 210 using a pointing device.

In the example shown, assume that a user of client 102 has entered the search query “car insurance” into input field 208 and has requested a search via icon 210. In such a case, webpage 206 may be generated to include one or more hotlinks 212-216. Hotlinks 212-216 may link to various webpages related to the topic of the query, car insurance. For example, hotlink 212 may link to a webpage that provides consumer tips regarding car insurance.

In some implementations, webpage 206 may also include an advertisement 218 which is selected in part on the search query entered via input field 208. For example, “car insurance” may be part of a set of keywords used within an advertising auction. If so, an auction server, such as auction server 104, may generate bids on behalf of advertisers and conduct an advertisement auction. For example, a particular advertiser that has selected the set of keywords as part of his or her auction parameters may place an automatically generated bid in an advertisement auction. If the advertiser is the winning bidder, advertisement 218 may be selected from the winner and provided to client 102 for presentation with webpage 206.

Bids in the advertisement auction may be based in part on predicted user behaviors regarding the selected advertisements. For example, an impression for advertisement 218 may correspond to advertisement 218 simply being presented to the user of client 102. If advertisement 218 includes a hotlink to a website of the advertiser, another user action for advertisement 218 may correspond to the user of client 102 clicking on advertisement 218. A further user action may correspond a conversion, where the user of client 102 performs a desired action while on the advertiser's website (e.g., making a purchase, downloading software, registering for a user account or marketing promotions, etc.).

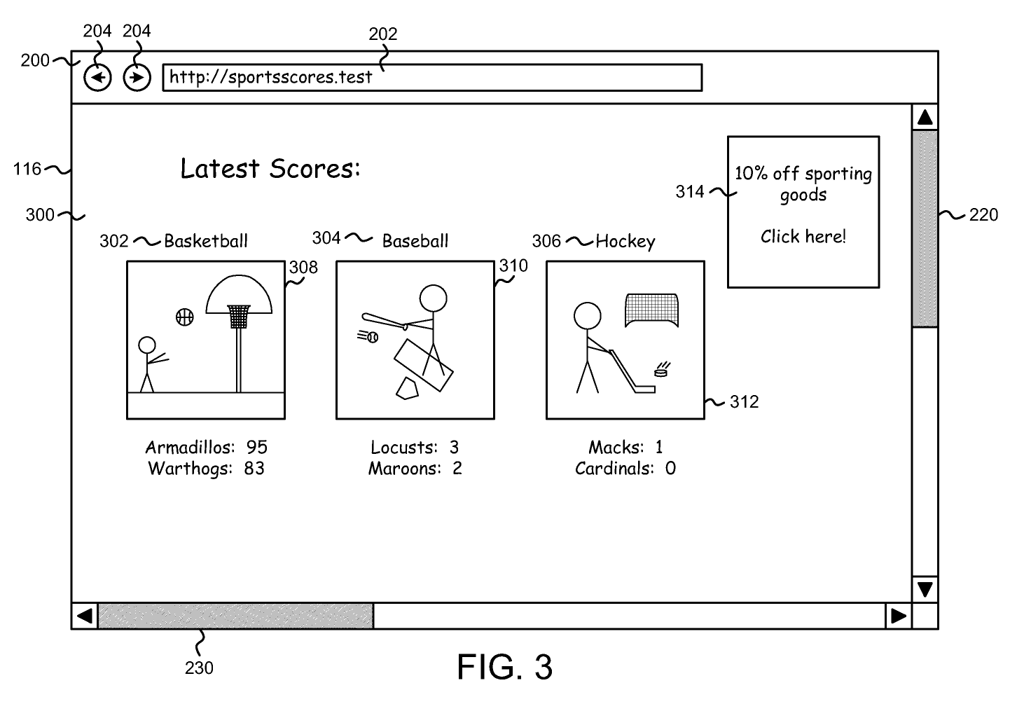

Referring now to FIG. 3, an illustration is shown of electronic display 116 displaying an example webpage 300. Similar to FIG. 2, client 102 may request webpage 300 from the address entered via field 202 of web browser 200. In the example shown, assume that the user of client 102 has navigated to webpage 300 located at the URL, http://sportsscores.test. For example, the user may navigate directly to webpage 300 by entering the URL in input field 202 or by clicking on a hotlink on another webpage that links to webpage 300.

As shown, webpage 300 may include various sports-related content. The content of webpage 300 may include text 302-306 and images 308-312. For example, text 302 and image 308 may relate to the sport of basketball while text 304 and image 310 may relate to the sport of baseball. Webpage 300 may also include an advertisement 314 selected by an auction server, such as auction server 104.

Advertisement 314 may be selected by an auction server based in part on the content of webpage 300. For example, webpage 300 may include one or more metatags that identify a topic of webpage 300. In other cases, text and/or image recognition may be used on text 302-306 and images 308-312, to identify webpage 300 as relating to the topic of sports. Like keywords in a search query, as shown in FIG. 2, keywords on webpage 300 may belong to a set of keywords and used to select advertisement 314. The advertiser of advertisement 314 may specify that he wishes to present advertisement 314 on sports-related webpages by selecting a sports-related set of keywords. Bids may then be generated on behalf of the advertiser in advertising auctions, to determine whether advertisement 314 is to be presented with webpage 300.

Similar to advertisement 218, bids in the advertisement auction in which advertisement 314 was selected may be based in part on predicted user behaviors regarding advertisement 314. For example, presenting advertisement 314 may be an impression, a selection of advertisement 314 may be a click, and a desired action performed by the user of client 102 in response to being presented with advertisement 314 may be a conversion. In some implementations, a participant in an advertising auction may specify whether his or her advertisements are to appear on search-related webpages, such as webpage 206, or on content-related webpages, such as webpage 300.

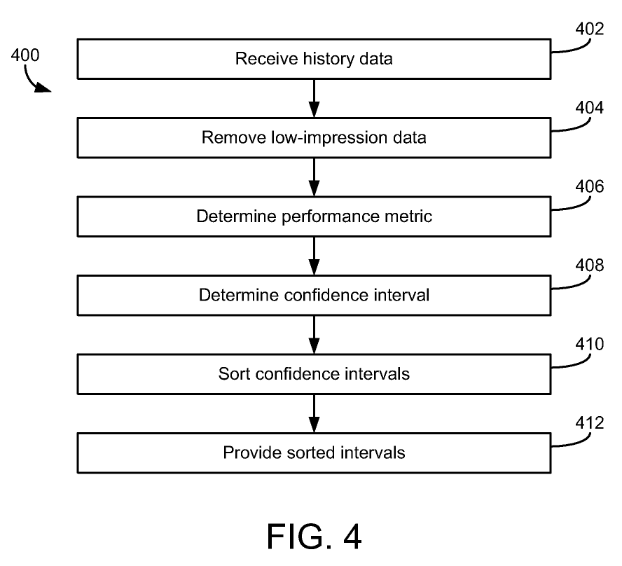

Referring now to FIG. 4, a flow diagram of an example process 400 for evaluating keyword performance is shown, according to various implementations. In general, process 400 allows an advertiser or other interested party to quickly evaluate the performance of different sets of keywords used to provide advertisements to users' devices. Process 400 may be implemented, for example, by an auction server (e.g., auction server 104) that conducts an advertising auction to select an advertisement from an advertiser or by another computing device configured to evaluate the performance of advertisements selected via online advertising auctions. The auction server or other computing device may execute machine instructions that cause one or more processors to perform process 400.

Process 400 includes receiving history data regarding the presentation of online advertisements (block 402). The history data may be indicative of the number of times an advertisement was selected in an advertising auction and provided to a client device, the bid amount or other financial cost for the advertiser to provide the advertisement to the client device, whether the advertisement was clicked or otherwise selected at the client device (e.g., via an input device such as a mouse, touch screen display, etc.), and/or user actions performed at the client device subsequent to the advertisement being clicked (e.g., making a purchase at the advertiser's website, registering for a user account, etc.). For example, a client identifier, such as a cookie, may be set on the client device that is provided the advertisement. Such a cookie may be used, for example, to gather history data regarding whether the client device is redirected to the advertiser's website in response to the advertisement being clicked. The history data may be from any period of time or a specific period of time (e.g., the past n-number of days). In some implementations, the history data may be aggregated for multiple advertisers that use the same or similar sets of keywords as auction parameters.

The received history data may be associated with a set of one or more keywords. In various implementations, an advertiser may specify a set of one or more keywords to control when advertisements from the advertiser are to be provided to a client device. For example, a user's search query at a search engine may be compared to the set of one or more keywords. If the keywords in the set match the search query, the advertiser may participate in an advertisement auction to compete for the ability to provide an advertisement with the search results. Similarly, a set of keywords may be used to determine whether a website being visited by a client device contains text that matches the keywords. If so, the advertiser may compete in an advertisement auction to place an advertisement on the visited webpage. The order in which the keywords appear in a search query or on a webpage may or may not be exact for there to be a match, according to some implementations. For example, an advertiser may specify that an exact phrase must be entered as a search query if the advertiser is to compete for the ability to place an advertisement with the search results.

A set of keywords may have an associated advertisement or multiple advertisements. For example, an online retailer running a sale on golf clubs may have multiple advertisements to notify users about the sale. In such a case, the advertiser may associate one or more of the advertisements with a particular set of keywords. For example, the advertiser may associate two advertisements with a first set of keywords and three advertisements with a second set of keywords. When a keyword match occurs, which advertisement is provided to a client device may selected randomly, based on performance metrics for the advertisements, or based on a quality score (e.g., how well the content of the advertisement matches the topic of the search or website).

In other implementations, various grouping techniques may be used to categorize sets of keywords. In some implementations, sets of keywords having similar concepts may be grouped and evaluated together. For example, assume that a first and second set of keywords both relate to shopping. In such a case, the history data for both sets may be aggregated, to evaluate the general concept of shopping. In some implementations, concepts may belong to a preexisting hierarchy of concepts or product categories. For example, a sets of keywords related to mobile telephones may be grouped in the category/Shopping/Electronic Devices/Mobile Telephones. In further implementations, sets of keywords may be grouped as n-grams, e.g., sets that contain the same word or words, or grouped based on user-defined words or phrases.

Process 400 optionally includes removing low-impression data from consideration (block 404). According to various implementations, an advertisement having an impression count below a threshold value may be ignored from consideration when evaluating the performance of its set of keywords. In some implementations, the set itself may be removed from further evaluation if the impression count for its associated advertisements is below the threshold value. For example, a set of one or more keywords may be excluded from performance comparisons with other sets, if the set has less than ten, twenty, fifty, one hundred, or any number of impressions. In various implementations, the threshold value may be set to a value between one hundred and one thousand impressions.

Process 400 includes determining one or more performance metrics using the history data (block 406). In some implementations, the history data may be analyzed to determine a performance metric for an advertisement associated with a set of one or more keywords. For example, assume that an advertiser has specified that an advertisement is to be provided with search results, whenever a user searches using the phrase “parking near the Leaning Tower of Pisa.” In such a case, performance metrics regarding the performance of the advertisement may be determined using the history data. In non-limiting examples, a performance metric may be a CTR, CPC, CVR, or CPA. For example, if the advertisement associated with the phrase “parking near the Leaning Tower of Pisa” is provided one hundred times with search results and the advertisement was clicked ten times, the advertisement may have a CTR of 10%. Therefore, this CTR may also be used as a performance metric for the phrase itself.

Process 400 includes determining a confidence for the one or more performance metrics (block 408). In general, a confidence interval provides a measure of reliability for a statistical value, such as a performance metric. A confidence interval includes upper and lower limit values in which the true performance metric may be found, to a certain degree of confidence. Any number of different calculations may be used to determine the confidence interval, according to various implementations. For example, the confidence interval may be a binomial proportion confidence interval based on the number of impressions and the performance metric. Such a binomial proportion confidence interval may be calculated as a normal approximation interval, a Wilson interval, a Clopper-Pearson interval, or any other form of binomial proportion confidence interval. For example, a Wilson interval may be calculated as follows:

$$\frac{p + \frac{1}{2 n} {z}_{1 - α \text{/} 2}^{2} \pm {{z}_{1 - α \text{/} 2} ( \frac{p ( 1 - p )}{n} + \frac{{z}_{1 - α \text{/} 2}^{2}}{4 {n}^{4}} )}^{1 / 2}}{1 + \frac{1}{n} {z}_{1 - α \text{/} 2}^{2}}$$

where p is the performance metric, n is the number of impressions, and z_{1-α/2} is the 1-α/2 percentile of the standard distribution. For example, z_{1-α/2} may be set to a value of 1.96, to obtain a 95% confidence interval.

In one example, assume that a set of one or more keywords has an associated advertisement that was presented 555 times and clicked by users 30 times. In such a case, the calculated CTR for the set will be 0.054. Based on this CTR, it may be assumed that 5.4% of users that are presented the advertisement based on the set of one or more keyword will also click on the advertisement. However, a 95% Wilson confidence interval gives a confidence interval of 0.038-0.076. Therefore, there is a 95% degree of confidence that the long-term CTR for the set will be somewhere between 0.038-0.076. In contrast, now assume that the advertisement was presented 5,555 times and clicked by users three hundred times. In such a case, the CTR will still be 0.054, but the 95% Wilson confidence interval will shrink to the range of 0.048-0.060.

Process 400 includes sorting the confidence intervals (block 410). In some implementations, the confidence intervals for the performance metrics may be sorted based on their upper or lower bounds. The sort may be performed optimistically or pessimistically, depending on whether the intervals are sorted by their upper or lower bounds. For example, sorting confidence intervals for CTRs or CVRs by their upper bounds may be viewed as an optimistic sort, since an advertiser may want a higher CTR or CVR than the currently calculated performance metric. Conversely, sorting confidence intervals for CPCs or CPAs by their lower bounds may also be viewed as an optimistic sort, since an advertiser may want a lower CPC or CPA.

The confidence intervals may be sorted in ascending or descending order. For example, a descending, pessimistic sort of confidence intervals for CTRs may be quickly analyzed to determine the best performing sets of keywords. In another example, an ascending, optimistic sort may be quickly analyzed to determine the worst performing sets of keywords. In some implementations, the system may be configured to notify an advertiser of the best or worst performing sets of keywords, based on their sorted confidence intervals. For example, the worst performing sets of keywords may be suggested to an advertiser as negative keywords, e.g., keywords that do not trigger an advertisement from the advertiser. In some cases, the negative keywords may be automatically set for the advertiser, e.g., without further action from the advertiser. In another example, variations of any well performing sets of keywords may be suggested to the advertiser or automatically added as another set of keywords for the advertiser.

Process 400 includes providing the sorted intervals (block 412). After the confidence intervals have been sorted, they may be provided to an electronic display or to a remote device for display. For example, the sorted intervals may be part of a generated performance report and presented on a display to an advertiser. In some implementations, the report may be an interactive report that allows an advertiser or other such party to specify report parameters. For example, an advertiser or other interested party may specify which performance metrics are to be presented in the interactive report, how the data in the report is to be sorted (e.g., ascending or descending), or which sets of keywords are to be compared in the report.

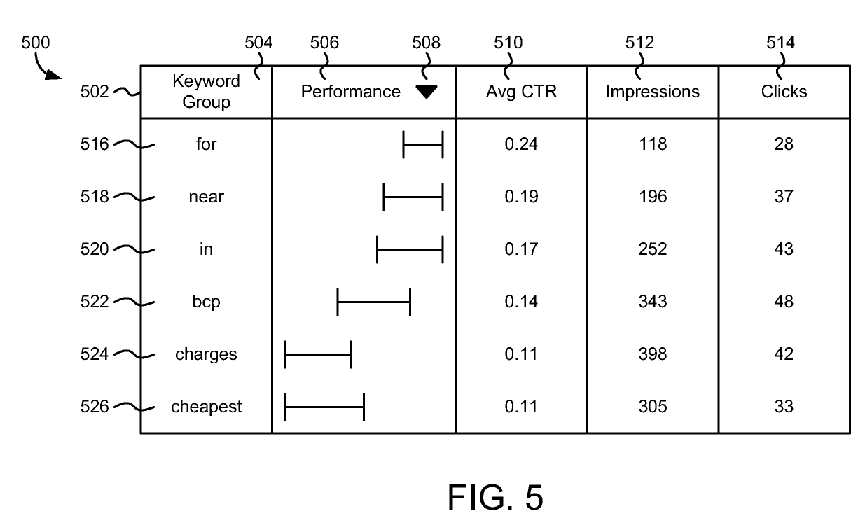

Referring now to FIG. 5, an example illustration of a performance report for sets of keywords used in an advertising system is shown, according to various implementations. In various implementations, performance report 500 may be an interactive report or a static report. Generally, performance report 500 include calculated performance information regarding the performance of different sets of keywords 516-526. Which performance information is presented in performance report 500 may be specified by an advertiser. For example, an advertiser or other interested party may specify that performance report is to report on the CTR, CVR, CPC, CPA, or similar advertising-related performance metric of sets 516-526.

As shown, performance report 500 may be provided to an electronic display 502 in communication with a processing circuit. Example electronic displays include, but are not limited to, computer monitors, smart television sets, a display of a mobile device (e.g., a smartphone, a laptop computer, a tablet computer, etc.), other displays for electronic devices. In some implementations, electronic display 502 may be a touch-screen display and configured to receive input and provide the input to its associated processing circuit. In some implementations, the processing circuit associated with electronic display 502 may generate performance report 500. In other implementations, performance report 500 may be provided to the processing circuit from a remote device, such as an auction server or other electronic device that stores history data regarding online advertisements.

Performance report 500 may include any number of columns and rows (e.g., as part of a grid of performance data). In the example shown, performance report 500 may include a keyword group column 504, a performance column 506, an average CTR column 510, an impression count column 512, and a click count column 514. Other example columns include a CVR column, a CPC column, a CPA column, and columns regarding raw confidence intervals for the CTR, CVR, CPC, and CPA values. Rows in performance report 500 may include any number of sets 516-526 of keywords. Sets 516-526 may correspond to various phrases grouped by their common keywords, in some implementations. For example, set 516 may include the query “parking for the Leaning Tower of Pisa” and set 518 may include the query “parking near the Leaning Tower of Pisa.” Thus, sets 516, 518 may include search phrases that vary by one or more keywords. In other implementations, performance report 500 may be represented using other graphical techniques, such as charts, graphs, and the like.

Average CTR column 510 may include performance metrics for sets 516-526 based on the raw data contained in impression count column 512 and click count column 514. The value for a set of keywords in average CTR column 510 may be determined by dividing the corresponding impression count in column 512 by the click count in column 514. For example, the average CTR for set 522 may be calculated as follows: CTR=48 clicks/343 impressions=0.14. Other data values and performance metrics may also be calculated and displayed in performance report 500 in a similar manner. For example, a conversion count may be included as another column in performance report 500 and a conversion rate may be calculated and displayed by dividing the conversion count by the impression count for a given set of keywords.

In some implementations, a raw confidence interval may be generated and displayed as part of performance report 500. For example, each value in average CTR column 510 may have an associated CTR confidence interval (e.g., a raw CTR range). Such information may be displayed numerically or graphically. For example, a confidence interval may be displayed in performance report 500 as an icon having a larger or smaller width, depending on its range of values. In some implementations, confidence intervals may be sorted by their upper or lower bounds. For example, the confidence intervals for the average CTRs may be sorted in descending order, to order the confidence intervals optimistically (e.g., those CTRs having the highest potential true CTRs may be shown at the top of performance report 500.

According to various implementations, all observed ranges of a performance metric may be normalized and displayed graphically as part of performance column 506. In general, performance column 506 may include data regarding a performance metric the advertiser wishes to optimize. For example, performance column 506 may include normalized confidence ranges for a CPC performance metric. The normalized ranges in performance column 506 may be sorted via input to sort button 508 (e.g., to sort the entries in performance column 506 in ascending or descending order). The sort may be done optimistically or pessimistically (e.g., based on their upper or lower bounds). As shown, performance column 506 has been sorted optimistically in descending order. Entries further to the right in performance column 506 may be considered to be better performing than entries further to the left in performance column 506. Similarly, the more narrow the entry in performance column 506, the more confidence its corresponding performance metric has. In cases in which a lower performance metric is considered better by an advertiser (e.g., a CPC, CPA, etc.), the normalized values may be inverted, allowing performance column 506 to be shown consistently for all performance metrics.

Implementations of the subject matter and the operations described in this specification can be implemented in digital electronic circuitry, or in computer software embodied on a tangible medium, firmware, or hardware, including the structures disclosed in this specification and their structural equivalents, or in combinations of one or more of them. Implementations of the subject matter described in this specification can be implemented as one or more computer programs, i.e., one or more modules of computer program instructions, encoded on one or more computer storage medium for execution by, or to control the operation of, data processing apparatus. Alternatively or in addition, the program instructions can be encoded on an artificially-generated propagated signal, e.g., a machine-generated electrical, optical, or electromagnetic signal, that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate components or media (e.g., multiple CDs, disks, or other storage devices). Accordingly, the computer storage medium may be tangible and non-transitory.

The operations described in this specification can be implemented as operations performed by a data processing apparatus on data stored on one or more computer-readable storage devices or received from other sources.

The term “client or “server” include all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, implementations of the subject matter described in this specification can be implemented on a computer having a display device, e.g., a CRT (cathode ray tube), LCD (liquid crystal display), OLED (organic light emitting diode), TFT (thin-film transistor), plasma, other flexible configuration, or any other monitor for displaying information to the user and a keyboard, a pointing device, e.g., a mouse, trackball, etc., or a touch screen, touch pad, etc., by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending webpages to a web browser on a user's client device in response to requests received from the web browser.

Implementations of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described in this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The features disclosed herein may be implemented on a smart television module (or connected television module, hybrid television module, etc.), which may include a processing circuit configured to integrate Internet connectivity with more traditional television programming sources (e.g., received via cable, satellite, over-the-air, or other signals). The smart television module may be physically incorporated into a television set or may include a separate device such as a set-top box, Blu-ray or other digital media player, game console, hotel television system, and other companion device. A smart television module may be configured to allow viewers to search and find videos, movies, photos and other content on the web, on a local cable TV channel, on a satellite TV channel, or stored on a local hard drive. A set-top box (STB) or set-top unit (STU) may include an information appliance device that may contain a tuner and connect to a television set and an external source of signal, turning the signal into content which is then displayed on the television screen or other display device. A smart television module may be configured to provide a home screen or top level screen including icons for a plurality of different applications, such as a web browser and a plurality of streaming media services, a connected cable or satellite media source, other web “channels”, etc. The smart television module may further be configured to provide an electronic programming guide to the user. A companion application to the smart television module may be operable on a mobile computing device to provide additional information about available programs to a user, to allow the user to control the smart television module, etc. In alternate embodiments, the features may be implemented on a laptop computer or other personal computer, a smartphone, other mobile phone, handheld computer, a tablet PC, or other computing device.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product embodied on a tangible medium or packaged into multiple software products.

Thus, particular implementations of the subject matter have been described. Other implementations are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking or parallel processing may be utilized.

1. A method for configuring a data structure for ready access to confidence interval data comprising:
retrieving, by a processing circuit from a memory, a plurality of historical data blocks, each historical data block including a set of one or more keywords associated with a metric parameter value, the plurality of historical data blocks including at least two different sets of one or more keywords;
calculating, by the processing circuit, for each of at least two different sets of one or more keywords, an aggregated metric from metric parameter values associated with the set of one or more keywords;
determining, by the processing circuit, a confidence interval for each of the aggregated metrics, the confidence interval having an upper bound and a lower bound;
generating, by the processing circuit, a data structure including a plurality of aggregate data blocks; and
assigning, by the processing circuit, to each aggregate data block:
one of the at least two different sets of one or more keywords of the historical data blocks,
the aggregated metric corresponding to the assigned set of one or more keywords, and
the confidence interval for the assigned aggregated metric.

2. The method of claim 1, wherein each keyword corresponds to a search term used in a search engine.

3. (canceled)

4. The method of claim 1, further comprising identifying, by the processing circuit, worst-performing sets of keywords by sorting the aggregate data clocks by their assigned confidence intervals based on the upper bounds, and generating a performance report including the worst-performing sets of keywords.

5. The method of claim 1, wherein assigning the confidence intervals comprises calculating Wilson intervals to yield confidence intervals having a predetermined confidence level.

6. The method of claim 1, wherein the aggregated metric includes a click-through-rate, a conversion-rate, an average cost-per-click, or an average cost-per-action.

7. The method of claim 1, wherein
assigning, by the processing circuit, confidence intervals to the aggregate data blocks is performed responsive to determining that a total number of instances of the set of keywords in the historical data blocks respectively associated with the confidence intervals is above a threshold value.

8. A system for storing readily accessible confidence interval data comprising a processor, coupled to a memory, configured to:
retrieve a plurality of historical data blocks, each historical data block including a set of one or more keywords associated with a metric parameter value;
store a plurality of aggregate data blocks, each aggregate data block including:
at least one of the sets of one or more keywords of the historical data blocks,
an aggregated metric, calculated by aggregating a plurality of metric parameter values of the historical data blocks which are associated with the at least one set of one or more keywords, and
an upper and lower bound of a confidence interval for the aggregated metric; and
sort or rank the aggregate data blocks based on their respective upper bounds and/or lower bounds.

9. The system of claim 8, wherein each keyword corresponds to a search term used in a search engine.

10. (canceled)

11. The system of claim 8, further comprising identifying worst-performing keywords by sorting or ranking the associated confidence intervals based on their respective upper bounds, and generating a performance report including the worst-performing keywords.

12. The system of claim 8, wherein assigning the confidence intervals comprises calculating Wilson intervals to yield confidence intervals having a predetermined confidence level.

13. The system of claim 8, wherein the aggregated metric includes a click-through-rate, a conversion-rate, an average cost-per-click, or an average cost-per-action.

14. The system of claim 8, wherein the processing circuit is configured to assign and store the confidence intervals to the aggregate data blocks responsive to determining that a total number of instances of the set of keywords in the historical data blocks associated with the confidence intervals is above a threshold value.

15.-20. (canceled)

21. The method of claim 1, wherein aggregating metric parameter values comprises determining an average rate related to the metric parameter values.

22. The method of claim 1, wherein aggregating metric parameter values comprises determining a weighted average of the metric parameter values.

23. The method of claim 1, further comprising determining, by the processing circuit prior to calculating the aggregated metric parameter values, that the metric parameter values respectively associated with the at least two different sets of one or more keywords of the historical data blocks are each above a predetermined threshold value.

24. The system of claim 8, wherein the processor is further configured to determine an average rate related to the metric parameter values, the average rate included in the aggregated metric parameter values.

25. The system of claim 8, wherein the processor is further configured to determine a weighted average of the metric parameter values, the weighted average included in the aggregated metric parameter values.

26. The system of claim 8, wherein the metric parameter values respectively associated with the at least two different sets of one or more keywords of the historical data blocks are each above a predetermined threshold value.
